(19) United States
(12) Patent Application Publication
(10) Pub. No.: US 2012/0133500 A1
(43) Pub. Date: May 31, 2012

(54) APPARATUS AND METHOD FOR GUIDING DEACTIVATION OF BATTERY SENSOR OF ISG VEHICLES

(75) Inventors: Jiyong YU, Pocheon-si (KR); Sejun KIM, Seoul (KR); Chongah GWON, Hwaseong-si (KR); Junghwan BANG, Hwaseong-si (KR)

(73) Assignee: HYUNDAI MOTOR COMPANY, Seoul (KR)

(21) Appl. No.: 13/194,576

(22) Filed: Jul. 29, 2011

(30) Foreign Application Priority Data
Nov. 30, 2010 (KR) 10-2010-0120850

(51) Int. Cl. B60Q 1/00

(52) U.S. Cl. 340/455

(57) ABSTRACT

An apparatus and method for guiding deactivation of a battery sensor of ISG vehicles is capable of informing a driver of operation prohibition when the battery sensor mounted on the ISG vehicles is deactivated. The apparatus for guiding deactivation of a battery sensor of ISG vehicles includes a display unit displaying that the battery sensor is deactivated; and an engine control unit determining whether the battery sensor normally operates or not, and controlling a display operation of the display unit based on the determination result.

### CROSS-REFERENCE TO RELATED APPLICATIONS

The present application claims priority to Korean Patent Application Number 10-2010-0120850 filed Nov. 30, 2010, the entire contents of which application is incorporated herein for all purposes by this reference.

### BACKGROUND OF INVENTION

1. Field of Invention

The present invention relates to an apparatus and method for guiding deactivation of a battery sensor of idle stop and go (ISG) vehicles, and more particularly, to an apparatus and method for guiding deactivation of a battery sensor of ISG vehicles which automatically stops an idling engine when the vehicles are stopped, and reactivates the engine when the vehicles are to be started after a predetermined time.

2. Description of Related Art

Among a variety of gases composing the atmosphere, a gas causing a green-house effect is referred to as a green-house gas. The green-house gas may include carbon dioxide, methane, nitrous oxide, Freon gas, ozone and so on. Actually, vapour plays the largest role in causing a natural green-house effect. However, a representative example of a green-house gas causing global warming includes carbon dioxide.

As global warming is accelerated from the second half of the 20th century, abnormal climate changes such as concentrated heavy rain, drought, and typhoon have rapidly increased. If the current pollution level is continuously maintained, it is expected that the worldwide green-house gas emission will approach such a level that seriously threatens the human beings and the ecosystem in the near future.

Accordingly, in order to deal with the global warming caused by the green-house gases, international cooperation for reducing the green-house gas emission is being promoted in many areas.

Currently, a variety of attempts are being made to reduce the green-house gas emission in the transportation field. For example, much research has been conducted on fuel economy improvement.

At this point in time, fuel economy improvement is becoming a hot topic, and an ISG system tends to be expanded and applied worldwide. The ISG system receives information on vehicle speed, engine rotation speed, cooling water temperature and so on and issues a command to stop its engine while the engine is idling. In other words, the ISG system automatically stops its idling engine when the vehicle is stopped during urban driving, for example, when the vehicle waits at a red light, and restarts the engine when the vehicle is to be started after a predetermined time. The ISG system may be referred to as an idle stop control system or the like. The ISG system may accomplish a fuel economy effect of about 5 to 15% in an actual fuel economy mode. A vehicle having such an ISG system mounted therein is referred to as an ISG vehicle.

In commercial vehicles such as a taxi, a battery sensor is deactivated due to the battery-related repair, and thus the operation of ISG logic is frequently turned off (prohibited).

In such a case, customer complaints may be caused by the frequent limitation of the ISG logic. Furthermore, the battery sensor for recognizing the battery state may not exhibit its function.

In other words, an essential condition of the ISG vehicle is battery monitoring. The ISG vehicle includes the battery sensor mounted therein, in order to check the battery state.

Due to the characteristics of the battery sensor, however, when the battery is detached to repair the battery sensor or to replace the battery, the vehicle should be parked for about four hours, in order to activate the battery sensor. Otherwise, the ISG logic is not operated. In particular, commercial vehicles such as a taxi need to be regularly repaired, and thus the battery sensor thereof is frequently deactivated. In such a case, the ISG logic is not operated without any signs, and thus complaints may be caused by a user who uses the ISG vehicle.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

The present invention has been made in an effort to provide an apparatus and method for guiding deactivation of a battery sensor of idle stop and go (ISG) vehicles, which is capable of informing a driver of operation prohibition when the battery sensor mounted on the ISG vehicles is deactivated.

Various aspects of the present invention provide an apparatus for guiding deactivation of a battery sensor of ISG vehicles, which comprises a display unit displaying that the battery sensor is deactivated, and an engine control unit determining whether the battery sensor normally operates or not, and controlling a display operation of the display unit based on the determination result.

The display unit may display the deactivation by using a voice.

The display unit may display the deactivation by using a text.

The display unit may display the deactivation by using a voice or text.

The display unit may include a lighting or flickering lamp.

When the battery sensor abnormally operates, the engine control unit may control the display unit to perform a display operation indicating that the battery sensor is deactivated.

When the battery sensor abnormally operates, the engine control unit may block entry into an ISG mode and maintain the state, until the battery sensor is activated.

Other aspects of the present invention provide a method for guiding deactivation of a battery sensor of ISG vehicles, which comprises determining whether the battery sensor normally operates or not, and displaying deactivation of the battery sensor through a display unit, according to the determination result.

In the displaying of the deactivation, when the battery sensor abnormally operates, a display operation indicating that the battery sensor is deactivated may be performed.

The displaying of the deactivation may be performed by using a voice.

The displaying of the deactivation may be performed by using a text.

The displaying of the deactivation may be performed by using a voice or text.

The displaying of the deactivation may be performed by using a lighting or flickering lamp.

According to various aspects of the present invention, when the battery sensor is deactivated, the apparatus and method may inform a driver of the deactivation, thereby inducing the activation of the battery sensor.

Further, according to various aspects of the present invention, it may not only improve the battery durability, but also may increase the understanding of a driver. Therefore, it is possible to increase the merchantable quality related to the ISG system.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a block configuration diagram of an exemplary apparatus for guiding deactivation of a battery sensor of ISG vehicles according to the present invention.

FIG. 2 is a flow chart explaining an exemplary method for guiding deactivation of a battery sensor of ISG vehicles according to the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

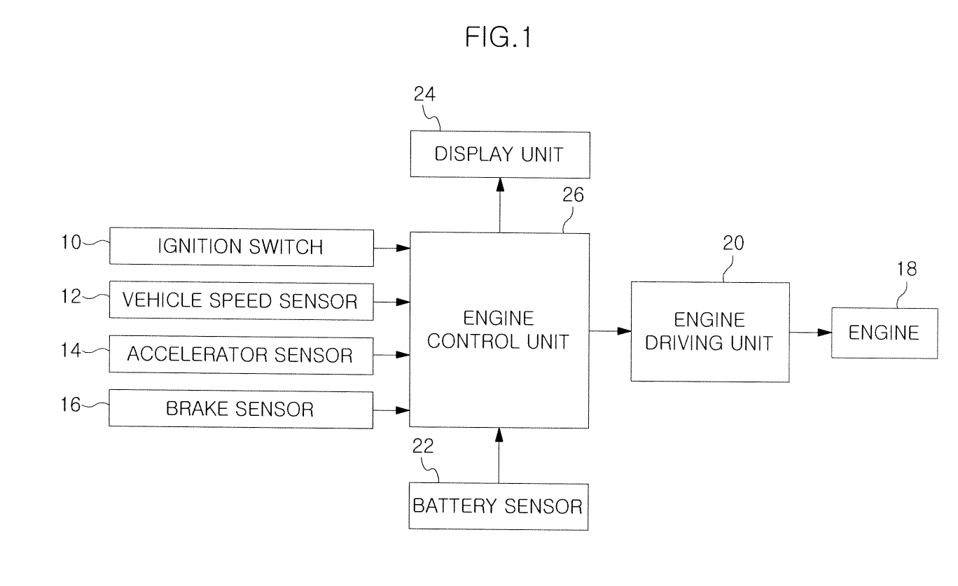

FIG. 1 is a block configuration diagram of an apparatus for guiding deactivation of a battery sensor of idle stop and go (ISG) vehicles vehicles according to various embodiments of the present invention. In the following descriptions of this specification, a vehicle refers to a vehicle having an ISG system mounted therein. For example, the vehicle includes a button positioned on an instrument panel at the front side of a driver's seat and configured to activate ISG logic. When the button is pressed, the ISG logic is operated. Alternatively, when the vehicle is stopped, the ISG logic may be automatically activated after a predetermined time, even though such a button is not provided.

Referring to FIG. 1, in order to automatically stop an engine 18 when the vehicle is stopped, for example, when the vehicle waits at a red light, the following conditions should be satisfied in a state in which an ignition switch 10 is turned on. That is, an output signal of a vehicle speed sensor 12 needs to indicate vehicle speed of “0(zero)”, an output signal of an accelerator sensor 14 needs to indicate that an accelerator pedal is not stepped on, and an output signal of a brake sensor 16 needs to indicate that a brake pedal is being stepped on. Furthermore, the following precedent conditions need to be met: the temperature of transmission oil falls within a predetermined range and the engine RPM is equal to or less than a predetermined value. Meanwhile, when a driver releases the brake pedal and steps on the accelerator pedal, stopped engine 18 is restarted.

In other words, an engine control unit 26 determines whether the engine is idling or not, based on the signals from ignition switch 10, vehicle speed sensor 12, accelerator sensor 12, and brake sensor 16, and then automatically stops or reactivates engine 18. Such an automatic idle stop control method (typical ISG logic) will be easily understood by those skilled in the art.

FIG. 1 illustrates that ignition switch 10, vehicle speed sensor 12, accelerator sensor 14, and brake sensor 16 are used to determine whether engine 18 is idle or not. However, in order to simplify the drawing and the configuration, an idle sensor may be used to determine whether engine 18 is idle or not, instead of ignition switch 10, vehicle speed sensor 12, accelerator sensor 14, and brake sensor 16. The idle sensor serves to detect an idle state of engine 18, convert the detected idle state into an electrical signal, and output the electrical signal. The idle sensor includes an idle switch. The idle switch has an operation characteristic of being turned on when the vehicle is idling. Furthermore, the idle switch has an operation characteristic of being turned off when the stopped engine is restarted. When the idle switch is turned on, engine control unit 26 may determine that the vehicle is stopped in an idle state.

An engine driving unit 20 serves to drive engine 18 based on a control signal from engine control unit 26. Engine driving unit 20 includes an injector which injects fuel toward engine 18.

A battery sensor 22 serves to detect a battery state. In other words, battery sensor 22 detects information required for determining a battery charge state, an activation ability and so on. Based on a signal from battery sensor 22, engine control unit 26 issues a command to operate, prohibit, or restart the ISG logic. For example, when the battery charge state is about 75% or more, engine control unit 26 operates the ISG logic, and when the battery charge state is less than about 75%, engine control unit 26 prohibits the ISG logic. Meanwhile, when the battery charge state becomes worse, the engine cannot be activated. Therefore, engine control unit 26 issues a command to restart the engine.

A display unit 24 serves to display that the battery sensor is deactivated, according to the control command of engine control unit 26. For example, display unit 24 may include a speaker to inform the driver of the deactivation state of the battery sensor through a sound such as a voice message which says “Battery sensor is currently deactivated”, for example. Alternatively, display unit 24 may include an LCD panel to inform the driver of the deactivation state of the battery sensor through a text such as a text message which says “Battery sensor is currently deactivated”, for example. Alternatively, display unit 24 may include a speaker and an LCD panel to inform the driver of the deactivation state of the battery sensor through a voice and a text. Alternatively, display unit 24 may include a lighting or flickering lamp. Furthermore, display unit 24 may inform the driver of the deactivation state of the battery sensor through a buzzer sound.

Engine control unit 26 determines whether battery sensor 22 normally operates or not, and controls the display operation of display unit 24 based on the determination result. When battery sensor 22 abnormally operates, engine control unit 26 issues a command to perform a display operation which shows that battery sensor 22 is deactivated. When battery sensor 22 abnormally operates, engine control unit 26 blocks entry into the ISG logic and maintains the state, until battery sensor 22 is activated.

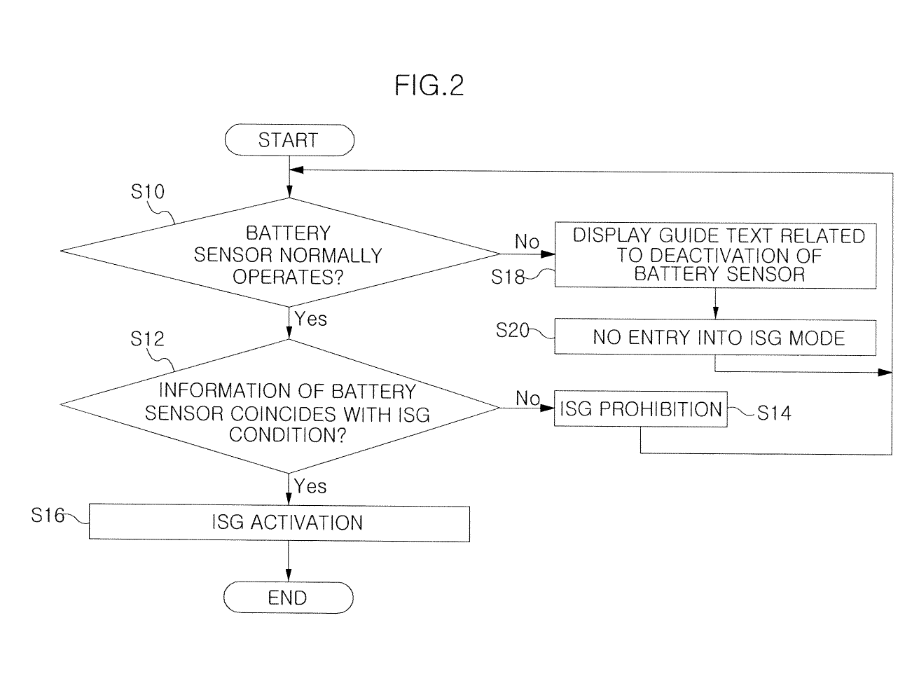

Now, the operation of the apparatus for guiding deactivation of a battery sensor of ISG vehicles according to various embodiments of the present invention will be described with reference to FIG. 2.

Engine control unit 26 determines whether battery sensor 22 normally operates or not (S10).

When power is reapplied to battery sensor 22 due to the vehicle repair or battery replacement, battery sensor 22 is deactivated for a predetermined time, for example, four hours.

When battery sensor 22 normally operates, for example, when information is outputted from battery sensor 22 (“Yes” at the step S10), engine control unit 26 determines whether the information from battery sensor 22 coincides with the ISG condition or not (S12).

According to the determination result, when the information from battery sensor 22 does not coincide with the ISG condition (“No” at the step S12), engine control unit 26 prohibits (turns off) the operation of the ISG logic (S14).

On the other hand, when the information from battery sensor 22 coincides with the ISG condition (“Yes” at the step S12), engine control unit 26 activates (turns on) the ISG logic (S16).

Meanwhile, when it is determined at the step S10 that battery sensor 22 does not operate normally (“No” at the step S10), engine control unit 26 determines that battery sensor 22 is in the deactivation state, based on the above-described reasons.

Accordingly, engine control unit 26 displays a guide text which says that battery sensor 22 is deactivated, through display unit 24. In this case, display unit 24 may include an LCD panel capable of displaying a text, for example. Alternatively, the guide text may be delivered through a voice which says that battery sensor 22 is deactivated. Furthermore, a lighting or flickering lamp or a buzzer sound may be used to indicate that battery sensor 22 is deactivated.

Then, engine control unit 26 blocks entry into the ISG mode for operating the ISG logic, and maintains the state, until battery sensor 22 is activated (S20).

The ISG vehicle driver recognizes the current state which is guided through display unit 24, that is, recognizes that battery sensor 22 is deactivated, and then tries to activate battery sensor 22.

For convenience in explanation and accurate definition in the appended claims, the terms front, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

1. An apparatus for guiding deactivation of a battery sensor of idle stop and go (ISG) vehicles, the apparatus comprising:
a display unit displaying that the battery sensor is deactivated; and
an engine control unit determining whether or not the battery sensor is operating normally, and controlling a display operation of the display unit based on an operational determination result.

2. The apparatus as defined in claim 1, wherein the display unit performs the display operation by using any one of a voice and a text.

3. The apparatus as defined in claim 1, wherein the display unit comprises a lighted lamp or a flickering lamp.

4. The apparatus as defined in claim 1, wherein when the battery sensor abnormally operates, the engine control unit controls the display unit to perform a display operation indicating that the battery sensor is deactivated.

5. The apparatus as defined in claim 1. wherein when the battery sensor abnormally operates, the engine control unit blocks entry into an ISG mode and maintains the state, until the battery sensor is activated.

6. A method for guiding deactivation of a battery sensor of ISG vehicles, the method comprising:
determining whether or not the battery sensor is operating normally; and
displaying deactivation of the battery sensor through a display unit, according to a operational determination result.

7. The method as defined in claim 6, wherein, in the displaying of the deactivation, when the battery sensor abnormally operates, a display operation indicating that the battery sensor is deactivated is performed.

8. The method as defined in claim 6, wherein the displaying of the deactivation is performed by using any one of a voice and a text.

9. The method as defined in claim 6, wherein the displaying of the deactivation is performed by using a lighted lamp or a flicker lamp.
